(19) United States
(12) Patent Application Publication
(10) Pub. No.: US 2020/0151627 A1
(43) Pub. Date: May 14, 2020

(54) ADHERENCE MONITORING THROUGH MACHINE LEARNING AND COMPUTING MODEL APPLICATION

(71) Applicant: HVH Precision Analytics LLC, Wayne, PA (US)

(72) Inventors: Oodaye Shukla, Chesterbrook, PA (US); Jayant Apte, Wayne, PA (US)

(21) Appl. No.: 16/681,475

(22) Filed: Nov. 12, 2019

Related U.S. Application Data
(60) Provisional application No. 62/759,979, filed on Nov. 12, 2018.

(51) Int. Cl. G06Q 10/04; G06F 16/903; G06Q 50/00; G06F 17/18; G06N 20/00

(52) U.S. Cl. CPC G06Q 10/04; G06F 16/903; G06N 20/00; G06F 17/18; G06Q 50/01

(57) ABSTRACT

A computer-implemented method, computer program product, and system, include a processor(s) obtaining, records representing members of a sample population with identifying attributes associated with each member, where all members of the sample population possess a common trait. The processor(s) obtains intervention(s) to address the common trait; each intervention has configurable dynamic elements, The processor(s) query with parameters based on the attributes members of the sample population, data source(s), to extract environmental data relevant to the sample population. The processor(s) analyze the environmental data and the intervention(s) and select an intervention to deploy to the sample population. The processor(s) configures the selected intervention, to optimize performance of the selected intervention.

### CROSS-REFERENCE TO RELATED APPLICATIONS

This application claims priority to U.S. Provisional Application No. 62/759,979 filed Nov. 12, 2019, entitled, “IDENTIFYING AND DEPLOYING PATIENT INTERVENTIONS TO MAXIMIZE PATIENT ADHERENCE FOR HYDROXYUREA (HU) SCD PATIENTS” which is incorporated herein by reference in its entirety.

### FIELD OF INVENTION

The invention relates to the creation and utilization of machine-based learning algorithms to establish and identify data patterns and implement actions based on these patterns, in the absence of established knowledge regarding these patterns.

### BACKGROUND OF INVENTION

Individuals and populations with certain health conditions benefit from various interventions, which allow these populations to adhere to protocol or metrics that will generate higher possibilities of maintaining overall good health, despite the conditions. Interventions can include, but are not limited to, social interventions (e.g., community leader engagement, church/religious engagement, social activity-based) behavioral (e.g., modified pillboxes, simplified schedules, reinforcement or incentive aided), informational (HCP/nurse awareness and training, streamlined ED protocols), technological (e.g., mobile apps, portable sickle/blood tests, portable pain tests, and systemic (e.g., mobile unit, mobile hematologist, mobile blood test labs, specialized hospitals). However, each population and each patient varies in his or her ability to access these interventions and even if a particular intervention is known to be beneficial, how to position this intervention so that it is accessible to the individual or population such that the individual or population has a high probability of accessing the intervention (and thus adhering to wellness protocols to maintain good health), is not immediately apparent and/or generic. Different locations and populations will benefit from different types of interventions to the same medical conditions, and even if the locations and populations use the same type of interventions, how the intervention is implemented can also be unique to the location and population in order to encourage usage. Challenges exist in identifying an appropriate intervention configuring an intervention such that its efficacy is optimized.

### SUMMARY

Shortcomings of the prior art are overcome and additional advantages are provided through the provision of a method for determining interventions in order to maximize patient adherence improvement and to optimize the selection and deployment of these patient interventions. The method includes, for example, obtaining, by one or more processors, records representing members of a sample population, wherein each record for member of the sample population comprises one or more identifying attributes associated with each member, wherein all members of the sample population possess a common trait; obtaining, by the one or more processors, from a repository, based on the common trait, one or more interventions utilized to address the common trait, wherein each intervention comprises configurable dynamic elements defining implementation attributes for each intervention; querying, by the one or more processors, utilizing parameters based on the one or more identifying attributes associated with each member, for a portion of the members of the sample population, over an Internet connection, one or more data sources, to extract environmental data relevant to the sample population; analyzing, by the one or more processors, the environmental data and the one or more interventions to select an intervention of the one or more interventions to deploy to the sample population, wherein deployment of the intervention is predicted to address the common trait by meeting a pre-defined efficacy threshold; and configuring, by the one or more processors, the dynamic elements defining implementation attributes of the selected intervention, to optimize performance of the selected intervention, wherein the configured implementation of the intervention is predicted to meet or exceed the pre-defined efficacy threshold.

In some examples, the method also includes deploying, by the one or more processors, the configured selected intervention to clients utilized by members of the sample population.

In some examples, the environmental data is selected from data descriptive of items selected from the group consisting of: social aspects, physical aspects, socioeconomic aspects, and demographic aspects.

In some examples, one or more of the data sources comprises a social media platform.

In some examples, one or more of the data sources comprises a current events repository.

In some examples, the one or more interventions are selected from the group consisting of: a social intervention, a behavioral intervention, an informational intervention, a technological intervention, and a systemic intervention.

In some examples, the selected configured intervention is predicted within a given probability to address the common trait.

In some examples, the parameters based on the one or more identifying attributes associated with each member comprise a common parameter indicating a community characteristic of the sample population, and wherein types of data comprising the extracted environmental data relevant to the sample population is based on the community characteristic.

In some examples, the community characteristic is selected from the group consisting of: rural, urban, and suburban.

In some examples, the method includes updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention.

In some examples, the method includes monitoring, by the one or more processors, the sample population via the deployed configured selected intervention, for a given period of time;

In some examples, the method include determining, by the one or more processors, over the given period of time, if the configured implementation of the intervention has continuously met or exceeded the pre-defined efficacy threshold; and updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention, wherein the predictive model reflects the determination.

In some examples, the method includes obtaining, by the one or more processors, records representing members of the sample population; obtaining, by one or more processors, from the repository, based on the common trait, the predictive model of the optimized performance of the selected intervention; and deploying, by the one or more processors, the configured selected intervention to clients utilized by members of the sample population.

In some examples, the method includes monitoring, by the one or more processors, the sample population via the deployed configured selected intervention, for a given period of time; determining, by the one or more processors, over the given period of time, if the configured implementation of the intervention has continuously met or exceeded the pre-defined efficacy threshold of the predictive model; and updating, by the one or more processors, the predictive model, based on the determining.

Shortcomings of the prior art are overcome and additional advantages are provided through the provision of a computer program product for determining interventions in order to maximize patient adherence improvement and to optimize the selection and deployment of these patient interventions. The computer program product comprises a storage medium readable by a processing circuit and storing instructions for execution by the processing circuit for performing a method. The method includes, for instance: obtaining, by one or more processors, records representing members of a sample population, wherein each record for member of the sample population comprises one or more identifying attributes associated with each member, wherein all members of the sample population possess a common trait; obtaining, by the one or more processors, from a repository, based on the common trait, one or more interventions utilized to address the common trait, wherein each intervention comprises configurable dynamic elements defining implementation attributes for each intervention; querying, by the one or more processors, utilizing parameters based on the one or more identifying attributes associated with each member, for a portion of the members of the sample population, over an Internet connection, one or more data sources, to extract environmental data relevant to the sample population; analyzing, by the one or more processors, the environmental data and the one or more interventions to select an intervention of the one or more interventions to deploy to the sample population, wherein deployment of the intervention is predicted to address the common trait by meeting a pre-defined efficacy threshold; and configuring, by the one or more processors, the dynamic elements defining implementation attributes of the selected intervention, to optimize performance of the selected intervention, wherein the configured implementation of the intervention is predicted to meet or exceed the pre-defined efficacy threshold.

In some examples, the method performed by executing the instructions computer also includes deploying, by the one or more processors, the configured selected intervention to clients utilized by members of the sample population.

In some examples of the computer program product, the environmental data is selected from data descriptive of items selected from the group consisting of: social aspects, physical aspects, socioeconomic aspects, and demographic aspects.

In some examples of the computer program product, one or more of the data sources comprises a social media platform.

In some examples of the computer program product, one or more of the data sources comprises a current events repository.

In some examples of the computer program product, the one or more interventions are selected from the group consisting of: a social intervention, a behavioral intervention, an informational intervention, a technological intervention, and a systemic intervention.

In some examples of the computer program product, the selected configured intervention is predicted within a given probability to address the common trait.

In some examples of the computer program product, the parameters based on the one or more identifying attributes associated with each member comprise a common parameter indicating a community characteristic of the sample population, and wherein types of data comprising the extracted environmental data relevant to the sample population is based on the community characteristic.

In some examples of the computer program product, the community characteristic is selected from the group consisting of: rural, urban, and suburban.

In some examples, the method performed by executing the instructions computer also includes updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention.

In some examples, the method performed by executing the instructions computer also includes monitoring, by the one or more processors, the sample population via the deployed configured selected intervention, for a given period of time;

In some examples, the method performed by executing the instructions computer also includes determining, by the one or more processors, over the given period of time, if the configured implementation of the intervention has continuously met or exceeded the pre-defined efficacy threshold; and updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention, wherein the predictive model reflects the determination.

In some examples, the method performed by executing the instructions computer also includes obtaining, by the one or more processors, records representing members of the sample population; obtaining, by one or more processors, from the repository, based on the common trait, the predictive model of the optimized performance of the selected intervention; and deploying, by the one or more processors, the configured selected intervention to clients utilized by members of the sample population.

In some examples, the method performed by executing the instructions computer also includes monitoring, by the one or more processors, the sample population via the deployed configured selected intervention, for a given period of time; determining, by the one or more processors, over the given period of time, if the configured implementation of the intervention has continuously met or exceeded the pre-defined efficacy threshold of the predictive model; and updating, by the one or more processors, the predictive model, based on the determining.

Shortcomings of the prior art are overcome and additional advantages are provided through the provision of a system for determining interventions in order to maximize patient adherence improvement and to optimize the selection and deployment of these patient interventions. The system can include: a memory; one or more processors communicatively coupled to the one or more sensors and in communication with the memory; and program instructions executable by the one or more processors, via the memory, to perform a method, the method comprising: obtaining, by one or more processors, records representing members of a sample population, wherein each record for member of the sample population comprises one or more identifying attributes associated with each member, wherein all members of the sample population possess a common trait; obtaining, by the one or more processors, from a repository, based on the common trait, one or more interventions utilized to address the common trait, wherein each intervention comprises configurable dynamic elements defining implementation attributes for each intervention; querying, by the one or more processors, utilizing parameters based on the one or more identifying attributes associated with each member, for a portion of the members of the sample population, over an Internet connection, one or more data sources, to extract environmental data relevant to the sample population; analyzing, by the one or more processors, the environmental data and the one or more interventions to select an intervention of the one or more interventions to deploy to the sample population, wherein deployment of the intervention is predicted to address the common trait by meeting a pre-defined efficacy threshold; and configuring, by the one or more processors, the dynamic elements defining implementation attributes of the selected intervention, to optimize performance of the selected intervention, wherein the configured implementation of the intervention is predicted to meet or exceed the pre-defined efficacy threshold.

In some examples, the method performed by executing the instructions computer also includes deploying, by the one or more processors, the configured selected intervention to clients utilized by members of the sample population.

In some examples of the system, the environmental data is selected from data descriptive of items selected from the group consisting of: social aspects, physical aspects, socioeconomic aspects, and demographic aspects.

In some examples of the system, one or more of the data sources comprises a social media platform.

In some examples of the system, one or more of the data sources comprises a current events repository.

In some examples of the system, the one or more interventions are selected from the group consisting of: a social intervention, a behavioral intervention, an informational intervention, a technological intervention, and a systemic intervention.

In some examples of the system, the selected configured intervention is predicted within a given probability to address the common trait.

In some examples of the system, the parameters based on the one or more identifying attributes associated with each member comprise a common parameter indicating a community characteristic of the sample population, and wherein types of data comprising the extracted environmental data relevant to the sample population is based on the community characteristic.

In some examples of the system, the community characteristic is selected from the group consisting of: rural, urban, and suburban.

In some examples, the method performed by executing the instructions computer also includes updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention.

In some examples, the method performed by executing the instructions computer also includes monitoring, by the one or more processors, the sample population via the deployed configured selected intervention, for a given period of time;

In some examples, the method performed by executing the instructions computer also includes determining, by the one or more processors, over the given period of time, if the configured implementation of the intervention has continuously met or exceeded the pre-defined efficacy threshold; and updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention, wherein the predictive model reflects the determination.

In some examples, the method performed by executing the instructions computer also includes obtaining, by the one or more processors, records representing members of the sample population; obtaining, by one or more processors, from the repository, based on the common trait, the predictive model of the optimized performance of the selected intervention; and deploying, by the one or more processors, the configured selected intervention to clients utilized by members of the sample population.

In some examples, the method performed by executing the instructions computer also includes monitoring, by the one or more processors, the sample population via the deployed configured selected intervention, for a given period of time; determining, by the one or more processors, over the given period of time, if the configured implementation of the intervention has continuously met or exceeded the pre-defined efficacy threshold of the predictive model; and updating, by the one or more processors, the predictive model, based on the determining.

Methods and systems relating to one or more aspects are also described and claimed herein. Further, services relating to one or more aspects are also described and may be claimed herein.

Additional features are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a workflow that illustrates various aspects of some embodiments of the present invention;

FIG. 2 is a workflow that illustrates various aspects of some embodiments of the present invention;

FIG. 3 is a workflow that illustrates various aspects of some embodiments of the present invention;

FIG. 4 is a workflow that illustrates various aspects of some embodiments of the present invention;

FIG. 5 illustrates various aspects utilized in some embodiments of the present invention;

FIG. 6 illustrates various aspects utilized in some embodiments of the present invention;

FIG. 7 is an illustration of the program code executed by one or more processors executing various aspects of some embodiments of the present invention related to a particular non-limiting example;

FIG. 8 is a technical environment into which aspects of some embodiments of the present invention can be implemented; and

FIG. 9 depicts one embodiment of a computing node that can be utilized in a cloud computing environment.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code.

Embodiments of the present invention include a computer-implemented method, a computer program product, and a computer system (including but not limited to a distributed computing environment, such as a cloud computing system), where the program code executed by at least one processor utilizes an activity-based intelligence (ABI) methodology to rapidly integrate data from multiple sources to discover relevant patterns, determine and identify change, and characterize those patterns to drive collection and create decision advantage. The patterns identified are utilized in embodiments of the present invention to implement various actions. For example, in embodiments of the present invention, the program code determines and configures one or more interventions for implementation in a specific population. In embodiments of the present invention, program code executed by one or more processors, identifies interventions for a given individual and/or group and models an adherence metric for the individual and/or group based on a data analysis indicating characteristics for implementing the interventions that will provide a “best” adherence and maintain a pre-defined health state for the individual and/or group. To determine and configure the “best” interventions, the program code rapidly integrates data from disparate data sources discussed to enable the generation of patterns and the subsequent identification of interventions and parameters for the interventions that fit these patterns, in a timely manner, such that relevant interventions can be recommended and implemented. Past challenges to enabling this process include an inability to gather and synthesis data in a timely manner in order to enable this benefit, hence, allowing for the integration of the aspects described herein into a practical application.

As illustrated herein, in embodiments of the present invention, based on a pre-defined geographic scenario (e.g., urban, suburban, and rural), the program code determines interventions in order to maximize patient adherence improvement and to optimize the selection and deployment of these patient interventions. Dependent on the location type (e.g., selected from a finite set), the program code utilizes various sources of healthcare and non-healthcare data to inform locations and intervention(s). The program code computes multiple metrics for adherence in order to develop a model to select an appropriate metric. The program code performs two stage modeling, including performing optimization between interventions and healthcare factors, and performing optimization between healthcare factors and the adherence metric. The program code can optimize adherence across combinations of interventions by leveraging mathematical modeling techniques (solvers), and defining decision variables, constraints, and objective functions.

Embodiments of the present invention combine data analytics and pattern prediction to enable program code executing on at least one processor to identify patterns within a data set in the absence of advance data defining the pattern. In an embodiment of the present invention, program code analyzes a data set to identify parameters comprising data points characteristic of certain populations from sources not specific to medical sources (e.g., crime, income, unemployment, smartphone ownership, social association rate, population without health insurance, insulin use (diabetes), primary care physicians, and percent of the population with food insecurity, hospitals, house prices, shopping centers, age, voting patterns, whether transportation to work includes biking/walking, hematologists. unemployment, traffic, medical insurance, social vulnerability, hazardous waste, lottery tickets, and education level, etc.). The program code adapts a machine learning algorithm to predict and optimize effective interventions to maximize patient adherence to health protocols, including determining parameters for the interventions (hence configuring the interventions for optimized impacts on the population). Thus, in some embodiments of the present invention, program code in embodiments of the present invention determines recognition patterns and utilizes these patterns to identify interventions and to optimize the interventions to meet a predicted adherence (in a specified population). Throughout this application, the example of deploying interventions to maximize patient adherence for hydroxyurea (HU) sickle cell disease (SCD) patients is used as a non-limiting example to demonstrate various aspects of some embodiments of the present invention. Generally, embodiments of the present invention include program code that enables maximization of patient adherence improvement and optimizes selection and deployment of patient intervention initiatives and resources.

Advantages provided by aspects of some embodiments of the present invention include: (1) a machine learning platform utilizing a broad and flexible range of analytics; (2) aspects that enable customization for use as a practical application in a healthcare setting by integrating health-care providers into the analytics processes; and/or (3) aggregation and analysis of data through an agnostic approach by which program code in embodiments of the present invention can access and analyze disparate global healthcare, social media, and/or environmental data sets.

Certain embodiments of the present invention represent improvements over known methods of data identification (as the program code in embodiments of the present invention mines, synthesizes, and analyzes data from disparate sources), both in the application of identifying possible interventions for individuals with physical/medical conditions and generating a recommendation (or implementation) that includes providing optimized interventions, recommending interventions, as well as in data management and data mining in general. For example, embodiments of the present invention enable the determination and identification of patterns based on an unlimited number of factors, given the ability of the program code to mine large data stores from a group of disparate data sources. Some embodiments of the present invention increase computational efficiency because, when building a profile to identify a given quality, the program code selects relevant features using not just prior knowledge and frequency count, but utilizes information theory mechanisms, including mutual information, and weights the variety of information utilized by, for example, truncating a the set of obtained features to establish a level of significance for each identified feature as measured via a mutual information measure.

As aforementioned, program code executed by at least one processor utilizes an ABI methodology to rapidly integrate data from multiple sources to discover relevant patterns, determine and identify change, and characterize those patterns to drive collection and create decision advantages. The ability of embodiments of the present invention to rapidly integrate data sources enable a holistic view of individuals or patients analyzed. Data utilized in embodiments of the present invention to establish and update the described patterns through machine learning can include, but are not limited to, interdisciplinary data of the following categories: biological (‘omics’ including but not limited to genomics, proteomics, etc.), environmental factors, social network interactions, built factors, entertainment, education, automobile incidents (including fatal car crashes), living accommodations (including low-rent units), social-economic factors, household income, house value, housing ownership or leasing arrangement (e.g., renter), employment, and/or education level. Data that can be integrated into embodiments of the present invention to produce and update patterns (models) can include societal (e.g., macro-economic, culture, social norms, policies, politics, religion, international trade and relations, agriculture and food, etc.), local (e.g., natural environment (air, water, climate, land, energy, etc.), built environment (building, places, streets parks, sanitation, transportation, etc.), health services (e.g., access to care, quality of care, coverage of services), socioeconomic environment (e.g., work environment, social network, local economy, school environment), and individual data (demography (e.g., age, gender, race/ethnicity), socioeconomic status (e.g., income, education, employment, insurance coverage, living condition), behavioral (e.g., diet, alcohol, tobacco, physical activity, coping skills), family (e.g., parenting individual(s)'s behavior, parent(s)′ economic status)). Embodiments of the present invention can be understood as an approach to extracting (data mining) insights from interdisciplinary data and recommending action items (or taking actions) based on these extracted insights.

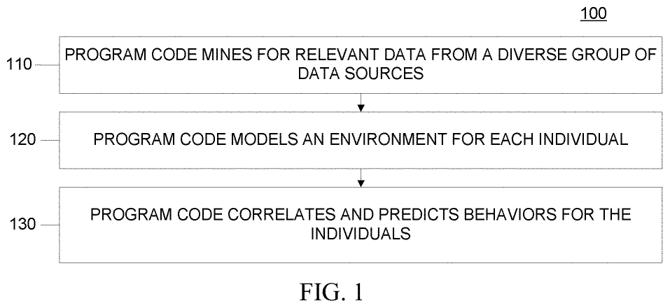

In embodiments of the present invention, program code executing on at least one processing device accesses disparate data sets and integrates these datasets to provide (and enact) actionable insights. Networks accessed by program code in embodiments of the present invention to access data to be integrated and analyzed include, but are not limited to, transportation networks, telecom networks, commuter stress measures, weather data, pollutant/toxin levels, and consumer profiles. FIG. 1 provides a workflow 100 of aspects of some embodiments of the present invention. Referring to FIG. 1, in some embodiments of the present invention, program code accesses a diverse group of data sources (e.g., transportation networks, telecom networks, commuter stress measures, weather data, pollutant/toxin levels, consumer profiles, etc.). The program code mines for relevant data from the diverse group of data sources (110). Based on data for individuals obtained from the data sources, the program code models an environment for each individual (120). Based on each environment, the program code correlates and predicts behaviors for the individuals (130). These predictions include, but are not limited to, the program code determining a relationship between the individual's health and physical environment and predicting purchasing habits of the individual (present and future) based on environmental influencers.

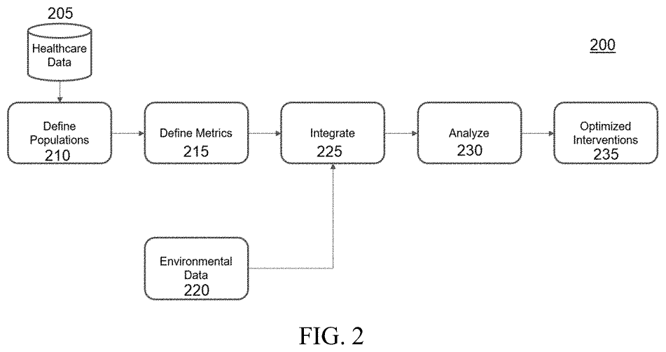

In embodiments of the present invention, the analyses illustrated by FIG. 1 can be executed by the program code for specific populations, which are identified in advance. FIG. 2 further illustrates a workflow 200 of embodiments of the present invention and in one example, can utilize an isolated SCD population, which the program code identifies from healthcare data. As aforementioned, the SCD population is merely one non-limiting example of a population to which aspects of the present invention can be applied. Referring to FIG. 2, in some embodiments of the present invention, program code executed by one or more processors accesses healthcare data 205 to define a population (e.g., SCD population) 210. As explained above, the program code does not diagnose this population but identifies the population based on data in the healthcare data 205 that it accesses. In an embodiment of the present invention, the program code defines metrics 215 representing a standard of care for the population. In some embodiments of the present invention, the program code accesses or otherwise obtains (e.g., via healthcare provider entry and/or program code that defines the metrics automatically) metrics representing a standard of care and/or data that the program code can interpret into metrics by applying a predefined model. It is these metrics to which the program code attempts to recommend patient factors to optimize a healthcare adherence to these metrics.

In embodiments of the present invention, as illustrated in FIG. 1, the program obtains additional data, referred to in this example as environmental data 220. By analyzing the environmental data 220, program code in embodiments of the present invention identifies intervention sites and methods using healthcare, social and environmental factors. The environmental data 220 in FIG. 2 can include, but is not limited to the location of the patients in the identified population 210, the health, environmental and socioeconomic profiles of the identified population 210, and/or barriers to access and compliance obstacles impacting individuals in the identified population.

In embodiments of the present invention, the environmental data 220 include data from one or more of the varied data sources discussed earlier and the program code integrates 225 the environmental data 220 into the aforementioned metrics and defined population records. The program code analyzes 230, the metrics and the environmental data as related to the defined population to determine patterns (data models) relevant to the population. As part of the analysis, in embodiments of the present invention, the program code assesses the data for predictive values, including but not limited to: 1) mapping/relating environmental factors to measures (metrics), and/or 2) mapping/relating single environmental factor(s) to disease/diagnostic codes from the healthcare data in the defines population, including but not limited to, International Statistical Classification of Diseases and Related Health Problems codes, referred to as ICD-9 codes and the newer ICD-10 codes. As a further part of the analysis, in some embodiments of the present invention, the program code assesses casual impacts, including but not limited to constructing linear and/or non-linear models. The latter of the models can be based on information theoretic principles such as mutual information. Hence, in embodiments of the present invention, the program code generates one or more predictive models related to a given population and correlates environmental factors and their impacts on this population.

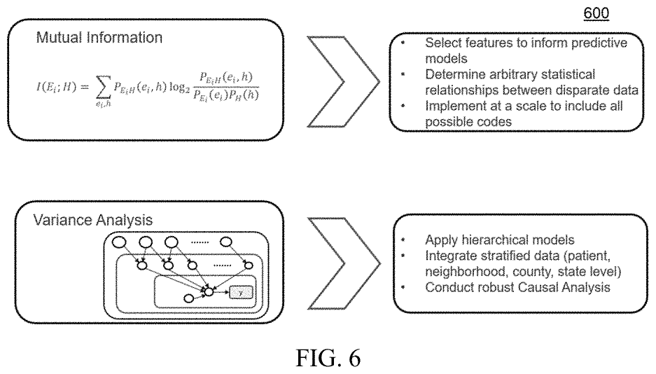

As illustrated in FIG. 2, the program code in embodiments of the present invention can analyze (mine) the data utilizing information theory (e.g., mutual information). The program code utilizes the mutual information measure to quantify the statistical relevance of every feature in the electronic data set(s) of medical records to a future diagnosis of a given disease. In some embodiments of the present invention, the program code computes the relative frequency of pertinent events (aspects from the various data sources) to assess casual impacts rank, including ranking these impacts (how a data point related to the individual is indicative or related to the individual's inclusion in the population) based on the mutual information measure. Based on mutual information, the one or more programs identify distinguishing features in categories that include environmental factors. Based on identifying the distinguishing features, the one or more programs generate predictors (e.g., distinguishing features when input into an adaptive data model predict an event of interest), that the one or more programs can apply to data sets where maximum adherence is sought from a given patient of an optimized result. In addition to mutual information, embodiments of the present invention can also utilize a variance analysis. The methodologies of mutual information and variance analysis are both illustrated in FIG. 6. These are utilized, in some embodiments of the present invention, to asses casual impacts in the analysis (FIG. 2, 230) performed by the program code in embodiments of the present invention.

Returning to FIG. 2, in embodiments of the present invention, the program code generates recommendations for an optimal set of interventions/actions to maximize adherence metrics 235. In embodiments of the present invention, in order for the determinations of the program code to continue to train the model (through machine-learning) the program code measures effectiveness of interventions via adherence metrics (e.g., MPR).

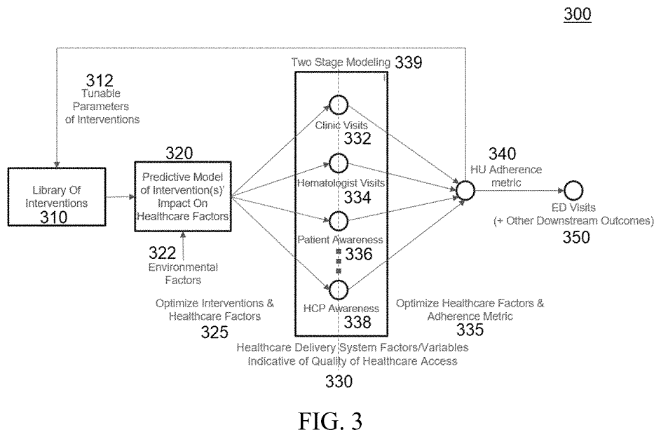

FIG. 3 is a workflow 300 of an iterative (machine-learning-based) process in embodiments of the present invention by which the aforementioned environmental factors are modeled by the program code to provide recommendations and actions that optimize a healthcare adherence metric for patients in a given population. Specifically, the workflow 300 of FIG. 3, provides an overview of a general approach to maximizing adherence, in accordance with some embodiments of the present invention. In embodiments of the present invention the program code applies the predictive model of interventions 320 it generated based on the environmental factors 322 (as illustrated in FIG. 3).

As explained herein, program code in embodiments of the present invention can utilize mutual information to designate a given intervention and/or to optimize that intervention for a given geographic area and a given population. As background, entropy is the information content of a random variable. For a discrete random variable X with support indexed by i, its entropy H(X) is defined as: H(X)=−Σᵢ pᵢ log₂ pᵢ (bits) where, pᵢ is the probability of ith outcome. Joint Entropy of discrete random variables X and Y with support sets indexed by i & j is defined as: H(X, =−Σᵢ p_{i,j} log₂ p_{i,j} (bits). Mutual Information (MI) between random variables X,Y is then defined as: I(X;Y)=H(X)+H(Y)−H(X,Y) (bits). Mutual Information is symmetric i.e. I(X;Y)=I(Y;X) as, I(X;Y)=H (X)+H (Y)−H (X,Y)=H(Y)+H(X)−H(X,Y)=I(Y;X). When determining the predictive value of variable X towards variable Y it is prudent to normalize mutual information and compute Normalized Mutual Information (NMI) as:

$$NMI ( X ; Y ) = \frac{I ( X ; Y )}{H ( Y )} \times 100 ( \% of target bits ) .$$

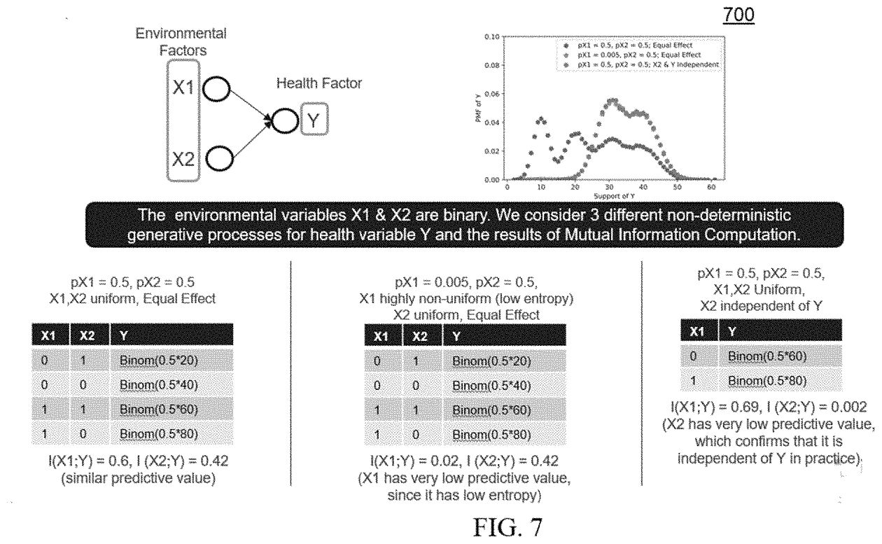

Mutual information is related to the predictive values (models) generated by the program code in embodiment of the present invention. Consider the following data generating model: Y=f(X)+ϵ, where ϵ˜Normal (0, σ²). Predictive value of a feature X toward target variable Y can be assessed using the Bayes Error Rate or Irreducible Error for prediction of Y from X. Bayes Error Rate (BER) is defined as the minimum possible error achievable by any classifier when Y is not a deterministic function of X. In case of the above data generating model, it can be shown to be σ². Entropy and Mutual Information can be used to provide Upper and Lower Bounds on BER. A lower bound is given by Fano's Inequality:

$${p}_{e} \geq \frac{H ( X ) - I ( X ; Y ) - h ( {p}_{e} )}{log ( \vert Y \vert - 1 )}$$

where h(pₑ) is the binary entropy function evaluated at pₑ. An upper bound is given by Hellman-Raviv as pₑ≤½(H(X)−I(X;Y)). Thus, the irreducible error can be thought to be inversely proportional to mutual information. FIG. 7 further illustrates various examples 700 of the program code applying these aspects in determining predictive values.

Returning to FIG. 3, the interventions to be utilized with the generated predictive models are obtained by the program code from a library of interventions 310 which comprises tunable parameters of interventions 312. The program code utilized the predictive models of interventions' impacts on healthcare factors 320 to optimize interventions and healthcare factors 325. The program code models healthcare delivery system factors/variables indicative of quality of healthcare access 330, in this example, through two stage modeling 339 (the two stages referring to performing optimization between interventions and healthcare factors 225, and performing optimization between healthcare factors and adherence metric 235). These variables/interventions (notional), include, but not limited to, in this example, clinic visits 332, hematologist visits 334, patient awareness 336, and HCP awareness 338. The program code optimizes interventions and healthcare factors 335. The modeling by the program code results in the program code determining a HU adherence metric 340. The adherence metric 340 includes tunable parameters of interventions 312, which the program code utilizes to update data in the library of interventions 310. Based on the adherence metric 340, the program code can predict and/or recommend an action for a given patient to optimize interventions and healthcare factors 335, such as emergency department (ED) visits and other downstream outcomes 350. In embodiments of the present invention, the program code can utilize one or more of multiple adherence metrics available for measuring adherence, the most common being MPR (e.g., hydroxyurea adherence) and PDC (proportion of days covered). Metrics can differ due to minor differences in computational methods and different metrics can present a different picture of the impact of various factors when used as a dependent variable in statistical models. Thus, in embodiments of the present invention, the program code can employ model averaging, which is a consensus/regularization scheme that can control for the choice of metric, and yield insights that are not dependent on the choice of metric.

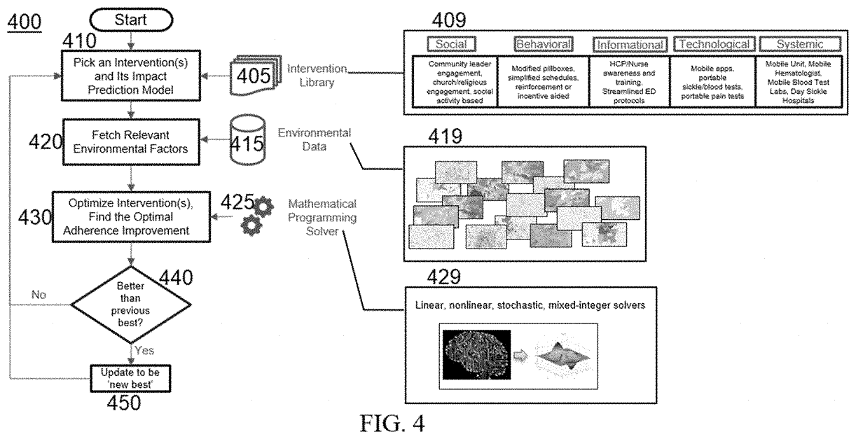

FIG. 4 is a workflow 400 that includes illustrations of various elements that inform the progression of the program code (executed by one or more processors) through the workflow 400, in some embodiments of the present invention. The workflow 400 illustrates how program code in embodiments of the present invention determines a set of optimal interventions to maximize adherence. FIG. 3 illustrated the derivation and updating of events in the intervention library 405. From the intervention library 405, the program code selects an initial one or more interventions and the impact prediction model associated with the interventions (410). The initial one or more interventions selected by the program code can be stored in the database as the best of one or more interventions relevant to a given population (e.g., SCD patients), which can maximize adherence. FIG. 4 illustrates contents 409 of a non-limiting example of an intervention library 405. In the intervention library 405, the contents 409 include, but are not limited to, social interventions (e.g., community leader engagement, church/religious engagement, social activity-based) behavioral (e.g., modified pillboxes, simplified schedules, reinforcement or incentive aided), informational (HCP/nurse awareness and training, streamlined ED protocols), technological (e.g., mobile apps, portable sickle/blood tests, portable pain tests, and systemic (e.g., mobile unit, mobile hematologist, mobile blood test labs, day sickle hospitals). The interventions listed as examples are relevant to the non-limiting SCD example.

Returning to FIG. 4, the program code fetches relevant environmental factors, based on the interventions (420). The program code can fetch these relevant environmental factors from environmental data 415, the contents 419 of which includes environmental data relevant to different geographic populations. The program code determines one or more optimal adherence improvements to optimize interventions. Hence determining the optimal one or more interventions (430). As illustrated in FIG. 4, the program code can utilize one or more mathematical programming solvers, including but not limited to linear, nonlinear, stochastic, mixed-integer solvers. The program code determines whether the optimal one or more interventions are better (more effective based on the aforementioned predictive model) than the initial one or more interventions (440). Based on determining that the optimal one or more interventions are better (more effective based on the aforementioned predictive model) than the initial one or more interventions the program code updates the intervention record(s) to reflect this change (450).

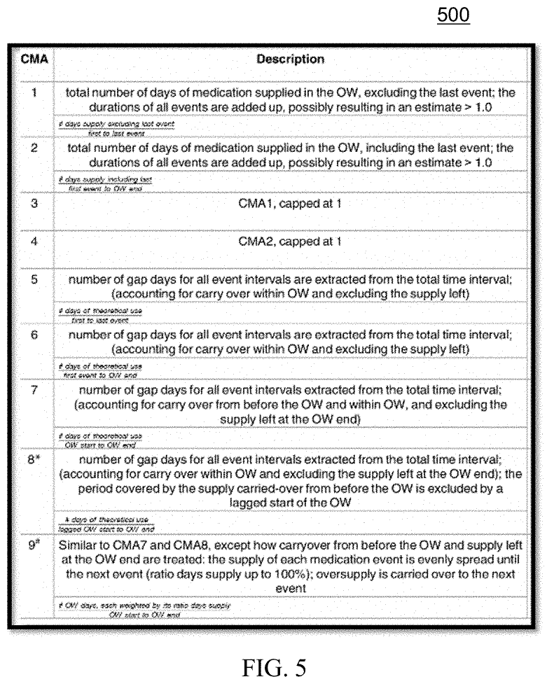

In some embodiments of the present invention, adherence metrics (FIG. 3, 340), (FIG. 2, 215), include a continuous multiple-interval measure of medication availability (CMA). A CMA is defined by four parameters: 1) how the observation window (OW) is delimited (whether time intervals before the first event and after the last event are considered); 2) whether CMA values are capped at 100%; 3) whether medication oversupply is carried over to the next event interval; and 4) whether medication available before a first event is considered in supply calculations or OW definition. FIG. 5 is a table 500 that illustrates various CMAs. CMAs can be mapped to common metrics: Medication Possession Ratio (MPR, corresponding to CMA1 and CMA2), Proportion of Days Covered (PDC; often used to describe variants from CMA3 to CMA 6), Simple CMA (variants can be computed for the whole OW), CMA-per-episode (variants computed for each treatment episode within an OW), Sliding-window-CMA (variants computed for repeated sliding windows within the OW). CMA7 extends the nominator to the whole OW interval, and by considering carry over both from before and within the OW. CMA8 is relevant for randomized controlled trials involving a new medication, when a patient on ongoing treatment may be more likely to finish the current supply before starting the trial medication. CMA9 is applied in longitudinal cohort studies with multiple repeated measures. Table 1 below is an example of computational results for CMAs automatically determined by the program code in embodiments of the present invention.

TABLE 1

| CMA | | CMA Per | Sliding Window |
|---|---|---|---|
| Type | Simple CMA | Episode (Avg.) | CMA (Avg.) |
| 1 | 0.435030278 | 0.582176776 | 0.616599985 |
| 2 | 0.214999268 | 0.732703315 | 0.51165347 |
| 3 | 0.41622559 | 0.538928643 | 0.577288066 |
| 4 | 0.214384189 | 0.714367878 | 0.465944706 |
| 5 | 0.412724769 | 0.532571045 | 0.569912403 |
| 6 | 0.213275332 | 0.710345237 | 0.447825516 |
| 7 | 0.213275332 | 0.710345237 | 0.20272551 |
| 8 | 0.213275332 | 0.710345237 | 0.195545477 |
| 9 | 0.213275332 | 0.710345237 | 0.206215753 |

In Table 1, the program code determines the Tunable Parameters for Simple CMA with the following computation: FW=OW=5*365 days=length of Symphony IDV® claims data. The program code determines Tunable Parameters for Per Episode CMA with the following computation: FW=OW=5*365 days=length of Symphony claims data, permissible gap=180 days. The CMA figures shown are the averages of all episodes for all patients. The program code determines Tunable Parameters for Sliding Window CMA with the following computation: FW=OW=5*365 days=length of Symphony claims data, sliding window start=0th day, sliding window end=5*365th day, sliding window duration=365 days, sliding window step size=73 days.

As discussed above, the application of various aspects of some embodiments of the present invention can vary based on the type of geographical population being evaluated (e.g., urban, rural, suburban).

Program code in embodiments of the present invention can be utilized to optimize a given intervention (to increase adherence) in urban populations. In an example urban population, the population is 652,236, HbSS Disease+Crisis=129, HbSS Disease+Crisis+HU=40, and Hydroxyurea Adherence (MPR)=0.32. The program code in embodiments of the present invention accesses data from a variety of non-medical sources (including social media), related to the following categories to inform the intervention type selected by the program code: crime, income, hospitals, house prices, shopping centers, age, voting patterns, whether transportation to work includes biking/walking, and hematologists. The program code optimizes interventions, specifically, for example, deployment of a mobile unit (to increase adherence). In some embodiments of the present invention, the program code applies modern optimization solvers to sift through billions of configurations, permutations, and combinations of the deployment scenario and converge towards an optimal solution. These solvers can account for uncertainty by using stochastic functions and random variables in the problem formulation. In this mobile unit deployment example, the program code solve Equation 1 below in a Stochastic Mixed Integer Program.

$${min}_{{U}_{i}} {\sum }_{i} {f}_{i} {U}_{i} - {\sum }_{i} {d}_{i} ( {x}_{i} , {y}_{i} , {t}_{i} ) {U}_{i} \qquad ( Equation 1 )$$

In Equation 1, Uᵢs are binary indicator variables indicating whether ith unit is deployed, fᵢs are the costs associated with deployment of ith unit, dᵢs are the aggregated efficacy random variables which are a function location of ith unit, hours of operation, and environmental factors. Based on applying Equation 1 and the analysis described, the program code can recommend specific actions, including but not limited to, where to station the mobile unit, operation times for the mobile unit, the route(s) of the mobile unit, and/or the expected number of patients.

Program code in embodiments of the present invention can be utilized to optimize a given intervention (to increase adherence) in rural populations. In an example rural population, population=11,670, HbSS Disease+Crisis=0, HbSS Disease+Crisis+HU=0, and Hydroxyurea Adherence=Unknown. In this non-limiting example, the program code in embodiments of the present invention accesses data from a variety of non-medical sources (including social media), related to the following categories: crime, income, unemployment, smartphone ownership, social association rate, population without health insurance, insulin use (diabetes), primary care physicians, and percent of the population with food insecurity. This data informs the intervention type selected by the program code. In this example, the program code selects and optimizes the intervention of making a mobile application available for the population. Smartphone use, as an environmental factor, informs us of the potential efficacy of a smartphone app as an intervention in a given geographical area. The prediction models implemented by the program code, in according with various aspects of the present invention, take into account multiple environmental factors. Because the program code determines, in this particular population, that smartphone use is low, the program code determines that to optimize this intervention, a combination of interventions would be more effective, which include, the mobile application, in combination with community-centric activities (church, school activities, etc.) and educational outreach efforts (social media). In some embodiments of the present invention, the program code can automatically deploy a mobile application optimized in accordance with modeled parameters to individuals within the population predicted to benefit from this intervention.

Program code in embodiments of the present invention can be utilized to optimize a given intervention (to increase adherence) in suburban populations. In a non-limiting example of a suburban population: population=122,979, HbSS Disease+Crisis=4, HbSS Disease+Crisis+HU=0, and Hydroxyurea Adherence=0. In this non-limiting example, the program code in embodiments of the present invention accesses data from a variety of non-medical sources (including social media), related to the following categories to inform the intervention type selected by the program code: crime, income, unemployment, traffic, medical insurance, social vulnerability, hazardous waste, lottery tickets, and education level. Suburban areas have features of both urban areas (education level, smart phone penetration, internet use) and rural areas (population density, traffic, roads). Thus, a combination of interventions can be jointly optimized and deployed by the program code. The program code, through applying a joint optimization model, determines, in one case, that deploying a mobile application, community engagement, and mobile health clinics, jointly, will increase adherence to a desired threshold.

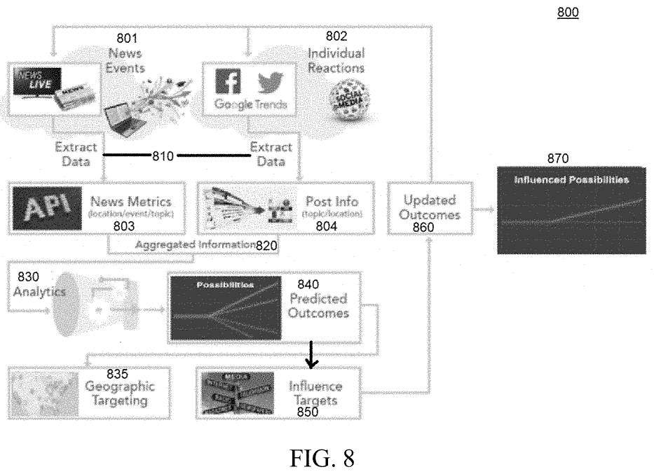

As discussed earlier, embodiments of the present invention utilize ABI to rapidly integrate data from multiple sources to discover relevant patterns, determine and identify change, and characterize those patterns to drive collection and create decision advantage. In embodiments of the present invention, the program code specifically utilizes ABI to identify interventions for a given individual and/or group and model an adherence metric for the individual and/or group based on performing a data analysis indicating characteristics for implementing the interventions that will provide a “best” adherence and maintain a pre-defined health state for the individual and/or group. As program code in embodiments of the present invention accesses, analyzes, and models utilizing data from a variety of sources, FIG. 8 is an illustration of a technical environment 800 into which aspects of some embodiments of the present invention can be implemented.

In the technical environment 800 of FIG. 8, each designation can includes one or more individual physical machines which can be accessed by the program code, which is executed by one or more processors. As illustrated in FIG. 8, in some embodiments of the present invention, program code executing on one or more processors accesses interventions and a prediction model for the intervention comprising updated outcomes 860, based on a defined target (group or individual) 850. Based on obtaining the updated outcomes the program code accesses relevant environmental data (e.g., FIG. 2, 220), and aggregates or integrates the data from the various sources (e.g., FIG. 2, 225) for analysis (e.g., FIG. 2, 230). In the illustrated technical environment 800, the program code accessed individual reactions 820 (e.g., social media, search engines, trends, Facebook, Twitter, etc.) as well as new events 801 related to the influence targets 850. The program code extracts data from these predominantly and/or completely non-medical data sources to generate metrics 803, based on locations, events, and/or topics, and post information 804 (from the individual reaction 802 sources, related, for example, to relevant topics and/or locations. The program code aggregates 820 the extracted data. The program code then analyzes the data 830 to generate predicted outcomes 840 (for relevant interventions from the updated outcomes 860). Informing the predicted outcomes is geographic targeting 835 as the weight of various interventions can changes depending on the defined type of population, in some embodiments of the present invention (i.e., rural, urban, and/or suburban). The defined type of population can determine whether a predicted intervention is appropriate for application. The program code provide and/or implements the predicted outcomes 840 (e.g., interventions configured with relevant parameters) to the influence targets 850. Based on the interventions implemented comporting or not comporting with the predicted outcomes (based on monitoring and/or user input), the program code updates the updated outcomes 860, providing a continuous machine-learning process for influenced possibilities 870.

Embodiments of the present invention include a computer-implemented method, a computer program product, and a system, where program code executed by one or more processors obtains records representing members of a sample population, wherein each record for member of the sample population comprises one or more identifying attributes associated with each member, wherein all members of the sample population possess a common trait. The program code obtains, from a repository, based on the common trait, one or more interventions utilized to address the common trait, wherein each intervention comprises configurable dynamic elements defining implementation attributes for each intervention. The program code queries, utilizing parameters based on the one or more identifying attributes associated with each member, for a portion of the members of the sample population, over an Internet connection, one or more data sources, to extract environmental data relevant to the sample population. The program code analyzes the environmental data and the one or more interventions to select an intervention of the one or more interventions to deploy to the sample population, wherein deployment of the intervention is predicted to address the common trait by meeting a pre-defined efficacy threshold. The program code configures the dynamic elements defining implementation attributes of the selected intervention, to optimize performance of the selected intervention, wherein the configured implementation of the intervention is predicted to meet or exceed the pre-defined efficacy threshold.

In some examples, the program code deploys the configured selected intervention to clients utilized by members of the sample population.

In some examples, the program code selects the environmental data from data descriptive of items selected from the group consisting of: social aspects, physical aspects, socioeconomic aspects, and demographic aspects.

In some examples, one or more of the data sources comprises a social media platform.

In some examples, one or more of the data sources comprises a current events repository.

In some examples, the program code selects the one or more interventions from the group consisting of: a social intervention, a behavioral intervention, an informational intervention, a technological intervention, and a systemic intervention.

In some examples, the program code predicts the selected configured intervention is within a given probability to address the common trait.

In some examples, the parameters based on the one or more identifying attributes associated with each member comprise a common parameter indicating a community characteristic of the sample population, and types of data comprising the extracted environmental data relevant to the sample population is based on the community characteristic.

In some examples, the community characteristic is selected by the program code from the group consisting of: rural, urban, and suburban.

In some examples, the program code updates, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention.

In some examples, the program code monitors the sample population via the deployed configured selected intervention, for a given period of time;

In some examples, the program code determined, over the given period of time, if the configured implementation of the intervention has continuously met or exceeded the pre-defined efficacy threshold. The program code updates, in the repository, data associated with the selected intervention of the one or more interventions utilized to address the common trait, the updating comprises retaining the configured dynamic elements defining the implementation attributes of the selected intervention as a predictive model of the optimized performance of the selected intervention, wherein the predictive model reflects the determination.

In some examples, the program code obtains records representing members of the sample population; obtaining, by one or more processors, from the repository, based on the common trait, the predictive model of the optimized performance of the selected intervention. The program code deploys the configured selected intervention to clients utilized by members of the sample population.

In some examples, the program code monitors the sample population, via the deployed configured selected intervention, for a given period of time. The program code determines, over the given period of time, if the configured implementation of the intervention has continuously met or exceeded the pre-defined efficacy threshold of the predictive model. The program code updates the predictive model, based on the determining.

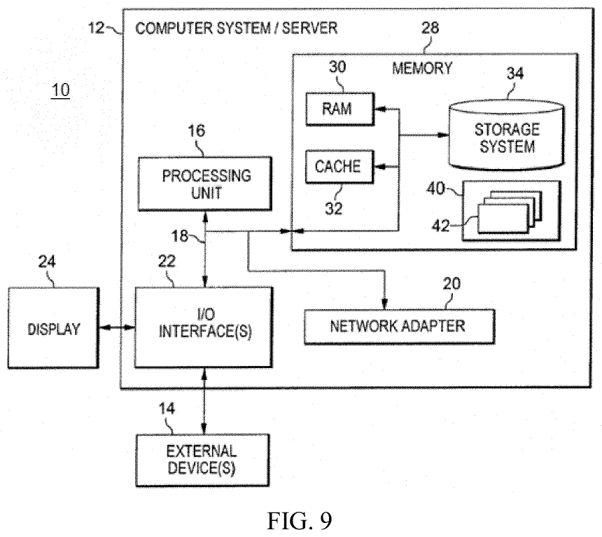

Referring now to FIG. 9, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the one or more processors that execute the program code can each comprise a cloud computing node 10 (FIG. 9) and if not a cloud computing node 10, then one or more general computing nodes that include aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
obtaining, by one or more processors, records representing members of a sample population, wherein each record for member of the sample population comprises one or more identifying attributes associated with each member, wherein all members of the sample population possess a common trait;
obtaining, by the one or more processors, from a repository, based on the common trait, one or more interventions utilized to address the common trait, wherein each intervention comprises configurable dynamic elements defining implementation attributes for each intervention;
querying, by the one or more processors, utilizing parameters based on the one or more identifying attributes associated with each member, for a portion of the members of the sample population, over an Internet connection, one or more data sources, to extract environmental data relevant to the sample population;
analyzing, by the one or more processors, the environmental data and the one or more interventions to select an intervention of the one or more interventions to deploy to the sample population, wherein deployment of the intervention is predicted to address the common trait by meeting a pre-defined efficacy threshold; and
configuring, by the one or more processors, the dynamic elements defining implementation attributes of the selected intervention, to optimize performance of the selected intervention, wherein the configured implementation of the intervention is predicted to meet or exceed the pre-defined efficacy threshold.

2. The computer-implemented method of claim 1, further comprising:
deploying, by the one or more processors, the configured selected intervention to clients utilized by members of the sample population.

3. The computer-implemented method of claim 1, wherein the environmental data is selected from data descriptive of items selected from the group consisting of: social aspects, physical aspects, socioeconomic aspects, and demographic aspects.

4. The computer-implemented method of claim 1, wherein one or more of the data sources comprises a social media platform.

5. The computer-implemented method of claim 1, wherein one or more of the data sources comprises a current events repository.

6. The computer-implemented method of claim 1, wherein the one or more interventions are selected from the group consisting of: a social intervention, a behavioral intervention, an informational intervention, a technological intervention, and a systemic intervention.

7. The computer-implemented method of claim 1, wherein the selected configured intervention is predicted within a given probability to address the common trait.

8. The computer-implemented method of claim 1, wherein the parameters based on the one or more identifying attributes associated with each member comprise a common parameter indicating a community characteristic of the sample population, and wherein types of data comprising the extracted environmental data relevant to the sample population is based on the community characteristic.

9. The computer-implemented method of claim 8, wherein the community characteristic is selected from the group consisting of: rural, urban, and suburban.

10. The computer-implemented method of claim 1, further comprising:
updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention.

11. The computer-implemented method of claim 2, further comprising:
monitoring, by the one or more processors, the sample population via the deployed configured selected intervention, for a given period of time;
determining, by the one or more processors, over the given period of time, if the configured implementation of the intervention has continuously met or exceeded the pre-defined efficacy threshold; and
updating, by the one or more processors, in the repository, data associated with the selected intervention of the one or more interventions utilized to address the common trait, wherein the updating comprises retaining the configured dynamic elements defining the implementation attributes of the selected intervention as a predictive model of the optimized performance of the selected intervention, wherein the predictive model reflects the determination.

12. The computer-implemented method of claim 1, further comprising:
obtaining, by the one or more processors, records representing members of the sample population;
obtaining, by one or more processors, from the repository, based on the common trait, the predictive model of the optimized performance of the selected intervention; and
deploying, by the one or more processors, the configured selected intervention to clients utilized by members of the sample population.

13. The computer-implemented method of claim 12, further comprising:
monitoring, by the one or more processors, the sample population via the deployed configured selected intervention, for a given period of time;
determining, by the one or more processors, over the given period of time, if the configured implementation of the intervention has continuously met or exceeded the pre-defined efficacy threshold of the predictive model; and
updating, by the one or more processors, the predictive model, based on the determining.

14. A computer program product comprising:
a storage medium readable by one or more processors and storing instructions executed by the one or more processors to perform a method, performing the method comprising:
obtaining, by the one or more processors, records representing members of a sample population, wherein each record for member of the sample population comprises one or more identifying attributes associated with each member, wherein all members of the sample population possess a common trait;
obtaining, by the one or more processors, from a repository, based on the common trait, one or more interventions utilized to address the common trait, wherein each intervention comprises configurable dynamic elements defining implementation attributes for each intervention;
querying, by the one or more processors, utilizing parameters based on the one or more identifying attributes associated with each member, for a portion of the members of the sample population, over an Internet connection, one or more data sources, to extract environmental data relevant to the sample population;
analyzing, by the one or more processors, the environmental data and the one or more interventions to select an intervention of the one or more interventions to deploy to the sample population, wherein deployment of the intervention is predicted to address the common trait by meeting a pre-defined efficacy threshold; and
configuring, by the one or more processors, the dynamic elements defining implementation attributes of the selected intervention, to optimize performance of the selected intervention, wherein the configured implementation of the intervention is predicted to meet or exceed the pre-defined efficacy threshold.

15. The computer program product of claim 14, performing the method further comprising:
deploying, by the one or more processors, the configured selected intervention to clients utilized by members of the sample population.

16. The computer program product of claim 14, wherein the environmental data is selected from data descriptive of items selected from the group consisting of: social aspects, physical aspects, socioeconomic aspects, and demographic aspects.

17. The computer program product of claim 14, wherein one or more of the data sources comprises a social media platform.

18. The computer program product of claim 14, wherein one or more of the data sources comprises a current events repository.

19. The computer program product of claim 14, wherein the one or more interventions are selected from the group consisting of: a social intervention, a behavioral intervention, an informational intervention, a technological intervention, and a systemic intervention.

20. A system comprising:
a memory;
one or more processors communicatively coupled to the memory; and
program instructions executed by the one or more processors, via the memory, to perform a method, performing the method comprising:
obtaining, by the one or more processors, records representing members of a sample population, wherein each record for member of the sample population comprises one or more identifying attributes associated with each member, wherein all members of the sample population possess a common trait;
obtaining, by the one or more processors, from a repository, based on the common trait, one or more interventions utilized to address the common trait, wherein each intervention comprises configurable dynamic elements defining implementation attributes for each intervention;
querying, by the one or more processors, utilizing parameters based on the one or more identifying attributes associated with each member, for a portion of the members of the sample population, over an Internet connection, one or more data sources, to extract environmental data relevant to the sample population;
analyzing, by the one or more processors, the environmental data and the one or more interventions to select an intervention of the one or more interventions to deploy to the sample population, wherein deployment of the intervention is predicted to address the common trait by meeting a pre-defined efficacy threshold; and
configuring, by the one or more processors, the dynamic elements defining implementation attributes of the selected intervention, to optimize performance of the selected intervention, wherein the configured implementation of the intervention is predicted to meet or exceed the pre-defined efficacy threshold.
